(19) United States
(12) Patent Application Publication
(10) Pub. No.: US 2020/0221668 A1
(43) Pub. Date: Jul. 16, 2020

(54) TRAINING ROBOT USING MOVABLE SMART HOME MONITORING ROBOT

(71) Applicant: VARRAM SYSTEM CO., LTD., Yuseong-gu (KR)

(72) Inventors: Byung Jo SUH, Yuseong-gu (KR); Kyoung Seok KIM, Yuseong-gu (KR)

(21) Appl. No.: 16/427,648

(22) Filed: May 31, 2019

(30) Foreign Application Priority Data
Jan. 10, 2019 (KR) 10-2019-0003345

(51) Int. Cl. A01K 15/02; G05D 3/12

(52) U.S. Cl. CPC A01K 15/021; G05D 1/021; G05D 3/12; A01K 15/025

(57) ABSTRACT

Provided is a training robot with an improved object discharging function including an object box including an elastic member; first driving means configured to rotate the object box; a base disposed spaced from the object box and including a discharge hole connected to an external space; and control means configured to control the first driving means such that when the object box rotates by the first driving means, the elastic member is in contact with an inner surface of the base and bends to generate an elastic force, when the object box rotates to a vicinity of the discharge hole, an object stored in the object box is discharged, the bent elastic member is unbent to a space of the discharge hole to release the elastic force, and the discharged object is pushed into the discharge hole.

### TECHNICAL FIELD

The present disclosure relates to a training robot having an object discharging function, and more particularly, to a training robot capable of supplying an object according to a control signal while the training robot moves manually or automatically.

### BACKGROUND ART

When a single-person household that has recently moved from their hometown and lives alone in another province, gradually grows, people who raise dogs and cats to appease their loneliness are increasing.

### DISCLOSURE

### Technical Problem

The present invention has been made to solve the above-mentioned problems, and provides a training robot with an improved object discharging function capable of more strongly discharging an object to the outside by using an elastic force generated in an elastic member while rotating an object box including the elastic member.

The present invention also provides a training robot with an improved object discharging function which is simple in structure and is miniaturized by having a structure for discharging an object by rotating an object box.

The present invention also provides a training robot with an improved object discharging function which may easily clean an object box not only by conveniently mounting the object box on the training robot but also easily separating the object box from the training robot.

The present invention also provides a training robot with an improved object discharging function capable of adjusting an intensity at which an object is discharged not only by easily separating an object box to easily detach an elastic member but also mounting the elastic member of various lengths to adjust an elastic force.

The present invention also provides a training robot with an improved object discharging function which may prevent an object from being abnormally discharged to the outside by allowing an object box to return to a specific position and stop after rotation.

Other objects and advantages of the present invention may be understood by the following description, and will be more clearly understood by the embodiments of the present invention. It will also be readily apparent that the objects and advantages of the invention may be realized and attained by means of the instrumentalities and combinations particularly pointed out in the appended claims.

### TECHNICAL SOLUTION

According to an aspect of the present disclosure, a training robot with an improved object discharging function includes an object box including an elastic member; a first driving means configured to rotate the object box; a base disposed to be spaced from the object box and including a discharge hole connected to an external space; and a control means configured to control the first driving means such that when the object box rotates by the first driving means, the elastic member is in contact with another member and bends to generate an elastic force, when the object box rotates to a vicinity of the discharge hole, an object stored in the object box is discharged, the bent elastic member is unbent to a space of the discharge hole to release the elastic force, and the discharged object is pushed into the discharge hole.

The control means maybe configured to control the first driving means such that when the object box rotates by the first driving means, the elastic member is in contact with an inner surface of the base and bends to generate the elastic force.

The base may further include a protrusion disposed on an inner side thereof, wherein the control means is configured to control the first driving means such that when the object box rotates by the first driving means, the elastic member is in contact with the protrusion and bends to generate an elastic force.

The object box may include a first box having a fastening groove; and a second box having a projection formed so as to be fitted into the fastening groove, thereby facilitating cleaning of the object box.

The object box may include a first box including a first half-hole formed at an end and configured to insert or discharge the object; and a second box including a second half-hole formed at an end of a part opposite to the first hole and configured to insert or discharge the object, wherein the first hole and the second hole are combined with each other when the first box and the second box are combined with each other to form a completed object box hole.

The elastic member may include a first member having an elastic force and exposed to an outside through an object box hole; and a second member coupled to an end of the first member in a vertical direction, wherein the object box further includes a fixing member capable of detachably attaching the second member coupled to the first member on an inner surface thereof.

A magnitude of an elastic force that the first member may have may vary according to a length of the first member exposed to an outside through the object box hole.

The base further includes a guide groove in contact with the elastic member to induce the elastic member to move to the discharge hole, wherein the elastic member rotates along the guide groove.

The control means may be configured to rotate the object box to control the object in the object box to be discharged through the discharge hole connected to an outside and then the control the object box to return to a specific position and stop.

The training robot may further include a position detection sensor configured to determine a rotational position of the object box, wherein the control means is configured to rotate the object box to control the object in the object box to be discharged through the discharge hole connected to an outside and then control the object box to return to a specific position and stop using rotational position information detected through the position detection sensor.

The object box may further include an object box hole, and wherein the control means is configured to control the object box hole of the object box to return to a specific position and stop by using the rotational position information detected through the sensor.

The control means may be configured to control the object in the object box to be easily discharged to the outside through the discharge hole by shaking the object box by a predetermined number of times after rotating the object box by a predetermined angle.

The training robot may further include a position detection sensor capable of detecting a rotational position of the object box, wherein the object box further includes an object box hole, and wherein the control means is configured to control the object in the object box to be easily discharged to the outside through the discharge hole by shaking the object box by a predetermined number of times when the object box hole enters a set distance from the discharge hole using rotational position information detected through the sensor.

The training robot may further include a discharge detection sensor configured to detect whether the object is discharged through the discharge hole or the object box hole, wherein the control means is configured to control the object box to rotate once more such that the object in the object box is discharged to the outside through the discharge hole when the object is not discharged based on a signal received from the discharge detection sensor.

The training robot may further include a moving means; and a second driving means disposed between the moving means and the base and connected to the moving means, wherein the control means is configured to control the second driving means to drive the moving means and move the training robot.

### Advantageous Effects

According to the disclosed present invention, an object may be more strongly discharged to the outside by using an elastic force generated in an elastic member while rotating an object box including the elastic member.

Also, a structure may be simple and miniaturized by having a structure for discharging an object by rotating an object box.

Also, an object box may be easily cleaned not only by conveniently mounting the object box on the training robot but also easily separating the object box from the training robot.

Also, an intensity at which an object is discharged may be adjusted not only by easily separating an object box to easily detach an elastic member but also mounting the elastic member of various lengths to adjust an elastic force.

Also, an object may be prevented from being abnormally discharged to the outside by allowing an object box to return to a specific position and stop after rotation.

### DESCRIPTION OF DRAWINGS

FIG. 1 is a diagram for explaining a driving method of a training robot with an improved object discharging function according to an embodiment of the present invention.

FIG. 2 is a diagram for specifically explaining a training robot with an improved object discharging function according to an embodiment of the present invention.

FIG. 3 is a diagram for specifically explaining abase according to an embodiment of the present invention.

FIGS. 4 and 5 are diagrams for explaining an object box according to an embodiment of the present invention.

FIGS. 6, 7, 8, and 9 are diagrams for explaining an object box rotation control method according to an embodiment of the present invention.

### DETAILED DESCRIPTION OF THE PREFERRED EMBODIMENT

Hereinafter, the present invention will be described in detail with reference to the accompanying drawings.

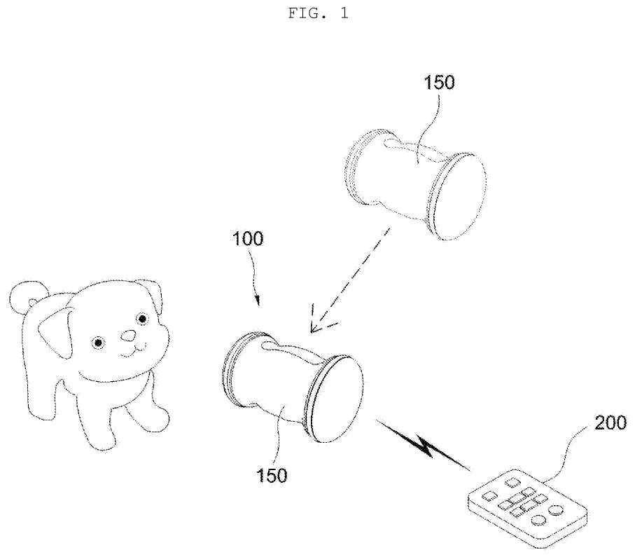

FIG. 1 is a diagram for explaining a driving method of a training robot 100 with an improved object discharging function according to an embodiment of the present invention.

The training robot 100 with the improved object discharging function may discharge an object in an object box to the outside according to the control signal from the terminal 200 capable of wireless communication. Here, the terminal 200 may be a device capable of transmitting signals through various wireless communication methods such as infrared communication, Wi-Fi, and the like. For example, the terminal 200 may be various types of devices capable of wireless communication such as a remote controller, a mobile phone, and the like.

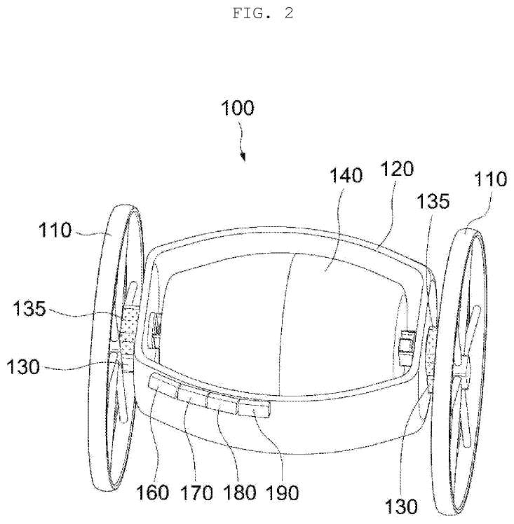

FIG. 2 is a diagram for specifically explaining the training robot 100 with the improved object discharging function according to an embodiment of the present invention.

Referring to FIGS. 1 and 2, the training robot 100 with the improved object discharging function may include moving means 110, a base 120, first driving means 135, second driving means 130, an object box 140, a housing 150, control means 160, a position detection sensor 170, a posture detection sensor 180, and an obstacle detection sensor 190.

The moving means 110 is capable of moving the training robot 100. In the present invention, the moving means 110 will be described as a wheel type, but is not limited thereto, and may be variously implemented.

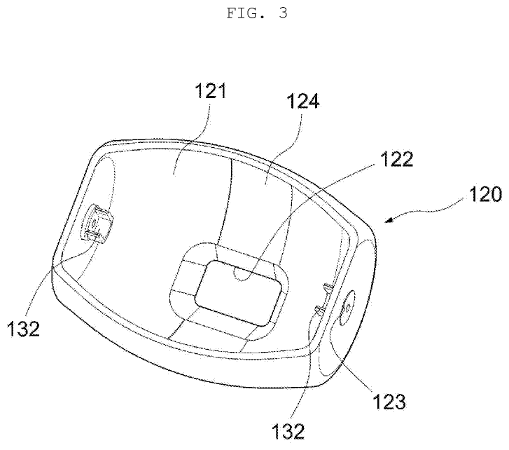

The base 120 may include an insertion groove into which the object box 140 including a discharge hole connected to an external space may be inserted. The base 120 will be described later with reference to FIG. 3.

The first driving means 135 may be disposed between the moving means 100 and the base 120 and may be mechanically connected to the object box 140. The first driving means 135 may rotate the object box 140 according to the control signal of the control means 160 and dispense an object present in the object box 140 to the outside.

The second driving means 130 may be disposed between the moving means 100 and the base 120 and may be mechanically connected to the moving means 100. The second driving means 130 may move the training robot 100 by driving the moving means 110 according to a control signal of the control means 160. Accordingly, the second driving means 130 may move the training robot 100 in various directions and speeds according to the control signal.

The object box 140 may include a space for containing the object and may include an object box hole for inserting or discharge the object.

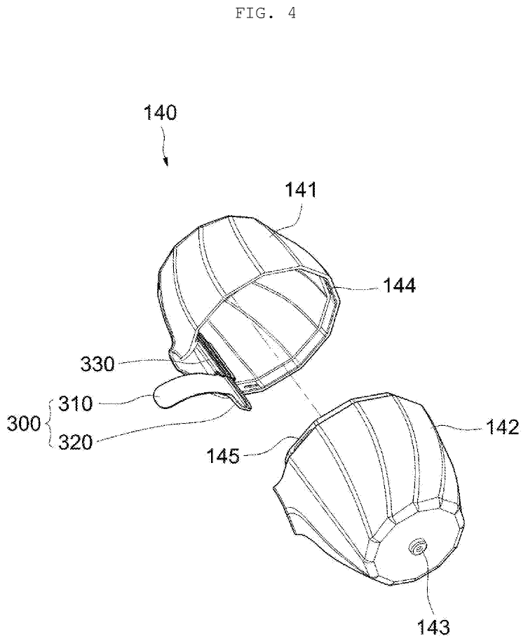

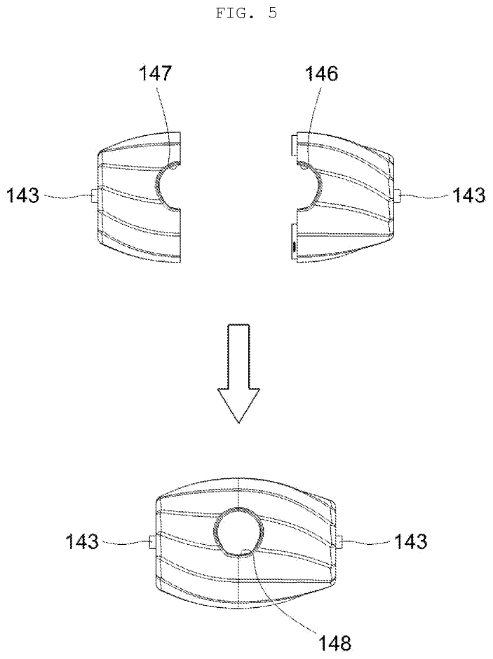

Also, since the object box 140 may be realized by coupling two boxes, it is easy to separate the boxes, and thus a user may easily clean the object box 140. A detailed description thereof will be given later with reference to FIGS. 4 and 5.

The housing 150 may cover components of the training robot 100 except for the moving means 110.

The control means 160 may integrally control the components included in the training robot 100. For example, the control means 160 may control the second driving means 130 to drive the moving means 110 to move the training robot 100. For another example, the control means 160 may rotate the object box 140 to control the object in the object box 140 to be discharged to the outside through the discharge hole.

The control means 160 may output sound set through a sound output means (not shown), and then rotate the object box 140 to discharge the object. Accordingly, if a specific sound is generated, it may be used for training by recognizing that the object is discharged.

The control means 160 may control the object box 140 to rotate and discharge the object inside the object box 140 connected to the outside through the discharge hole and then control the object box 140 to return to a specific position and stop. Here, a degree of rotation of the object box 140 and the specific position may be freely set by a user or the like.

The control means 160 may control an object box hole of the object box 140 to return to a specific position and stop using rotation position information obtained through the position detection sensor 170.

The position detection sensor 170 may determine a rotational position of the object box 140. For example, the position detection sensor 170 may determine how many degrees the object box 140 has rotated from its original position. For example, the position detection sensor 170 may be implemented in various forms such as a variable resistor, an infrared sensor, a gyro sensor, and the like.

The posture detection sensor 180 may sense a posture of the training robot 100. For example, the posture detection sensor 180 may be implemented as a gyro sensor or the like, and determine which azimuth angle the training robot 100 has from its original position. The control means 160 may determine whether the training robot 100 is inclined or inverted based on a signal received from the posture detection sensor 180.

The obstacle detection sensor 190 may sense surroundings of the training robot 100 in real time.

FIG. 3 is a diagram for specifically explaining the base 120 according to an embodiment of the present invention.

Referring to FIGS. 2 and 3, the base 120 may include an insertion groove 121, a discharge hole 122, engagement holes 123, and a guide groove 124.

The insertion groove 121 may be a groove into which the object box 140 may be inserted. The insertion groove 121 may have a depth at which a part of the object box 140 is exposed in a state where the object box 140 is inserted such that a user may easily mount or remove the object box 140.

The discharge hole 122 may be connected to an outer space, and may be a passage through which an object discharged from the object box 140 is discharged to the outside.

The engagement holes 123 may be formed at both sides of the base 120 and may mean holes through which fixing grooves 132 mechanically connected to the first driving means 135 pass. In other words, the engagement holes 123 maybe engaged into the fixing grooves 132 that pass therethrough, and the fixing grooves 132 may be engaged into protrusions formed on both sides of the object box 140.

The guide groove 124 may be in contact with the elastic member 300 to induce the elastic member 300 to move to the discharge hole 122.

FIGS. 4 and 5 are diagrams for explaining the object box 140 according to an embodiment of the present invention.

Referring to FIGS. 2, 3, and 4, the object box 140 may include a first box 141 having a fastening groove 144 and a second box having a projection 145 protruding therefrom to be fitted into the fastening groove 144. As described above, the object box 140 may have a structure in which two boxes may be easily coupled and separated, and have a structure in which a user may easily separate and facilitate the cleaning.

The elastic member 300 may include a first member 310 having an elastic force and exposed to the outside through an object box hole 148 and a second member 320 coupled to the end of the first member 310 in a vertical direction.

The object box 140 may further include a fixing member 330 capable of detachably attaching the second member 320 coupled to the first member 310 on an inner surface thereof. The fixing member 330 may be implemented in various forms such as a sliding form in which the second member 320 may be easily attached and detached.

The magnitude of an elastic force that the first member 310 may have may vary according to a length of the first member 310 exposed to the outside through the object box hole 148. For example, the longer the exposed length of the first member 310, the greater the elastic force, and the shorter the exposed length, the smaller the elastic force. Alternatively, the elastic force may be changed according to a material of the elastic member 300.

Since the elastic member 300 may be easily attached and detached using the fixing member 330, the user may easily change the elastic member 300 that needs to be replaced as well as may attach and detach any one of the elastic members 300 having different elastic forces to and from the fixing member 330 to have a desired elastic force.

Referring to FIGS. 2, 3, and 5, the object box 140 may include protrusions 143 on both end surfaces thereof. The protrusions 143 may be fixedly coupled to the fixing grooves 132 connected to the driving means 130. Accordingly, the control means 160 may drive the first driving means 135to rotate the object box 140, thereby discharging an object to an external space.

The object box 140 may include the first box 141 including a half first hole 146 formed at an end thereof for inserting or discharging the object, and the second box 142 including a half second hole 147 formed at an end of a part opposite to the first hole 146 for inserting or discharging the object. In this case, as the first box 141 and the second box 142 are coupled to each other, the first hole 146 and the second hole 147 may be combined to form the completed object box hole 148. The user may not only conveniently insert the object through the object box hole 148 but also conveniently separate the object box 140 by inserting a finger into the object box hole 148 when separating the object box 140.

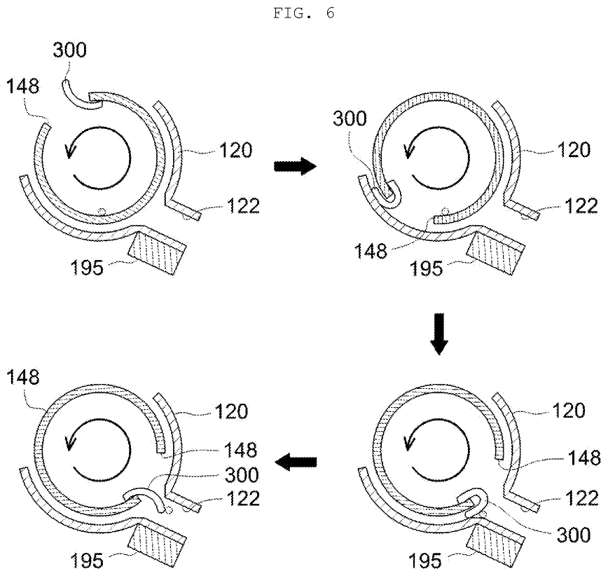

FIGS. 6, 7, and 8 are diagrams for explaining an object box rotation control method according to an embodiment of the present invention.

FIGS. 2 and 6 are diagrams for explaining a process of discharging an object while rotating the elastic member 300.

When the control means 160 controls the first driving means 135 to rotate the object box 140, the elastic member 300 is in contact with an inner surface of the base 120 and bends to generate an elastic force. In other words, the elastic member 300 is in contact with the inner surface of the base 120 and simultaneously is bent in a space between the base 120 and the object box 140.

The control means 160 controls the first driving means 135 to rotate the object box 140 toward the vicinity of the discharge hole 122 to discharge an object stored in the object box 140, and continuously rotate the object box 140 to cause the discharged object to be pushed into the discharge hole 122 such that the bent elastic member 300 is unbent to a space of the discharge hole 122 to release the elastic force.

Thus, the present invention may discharge the object to the outside more strongly by using the elastic force generated in the elastic member 300 while rotating the object box 140 including the elastic member 300.

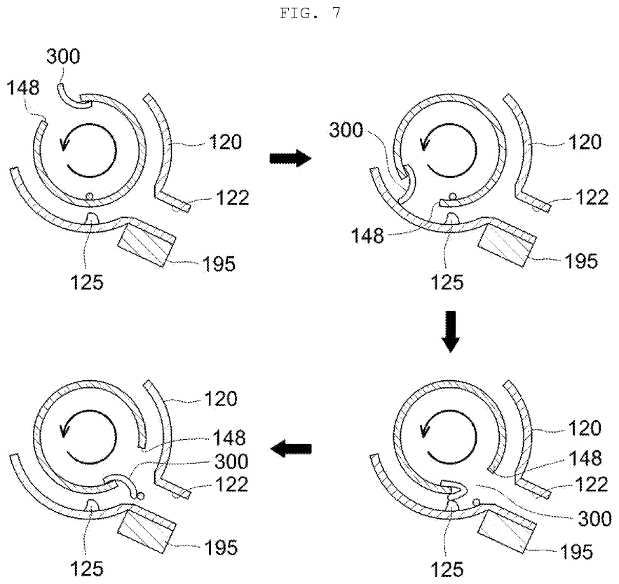

FIGS. 2 and 7 are diagrams for explaining a process of discharging an object while rotating the elastic member 300 according to another embodiment of the present invention.

The base 120 further includes a protrusion 125 disposed on an inner side thereof. The protrusion 125 maybe disposed at a certain distance away from the discharge hole 122 and at an optimum position where the object may be discharged into the discharge hole 122 while the elastic member 300 is released.

When the control means 160 controls the first driving means 135 to rotate the object box 140, the elastic member 300 is in contact with the protrusion 125 and bends to generate an elastic force.

The control means 160 controls the first driving means 135 to rotate the object box 140 to the vicinity of the discharge hole 122 to discharge the object stored in the object box 140, and continuously rotate the object box 140 to cause the discharged object to be pushed into the discharge hole 122 such that the elastic member 300 bent by the protrusion 125 is not in contact with the protrusion 125 to release the elastic force.

In other words, the elastic member 300 may maintain its original shape until it comes into contact with the protrusions 125, is in contact with the protrusions 125 to generate the elastic force, and is not in contact with the protrusions 125 to release the elastic force, thereby discharging the object into the discharge hole 122.

Thus, the present invention may discharge the object to the outside more strongly by using the elastic force generated in the elastic member 300 while rotating the object box 140 including the elastic member 300.

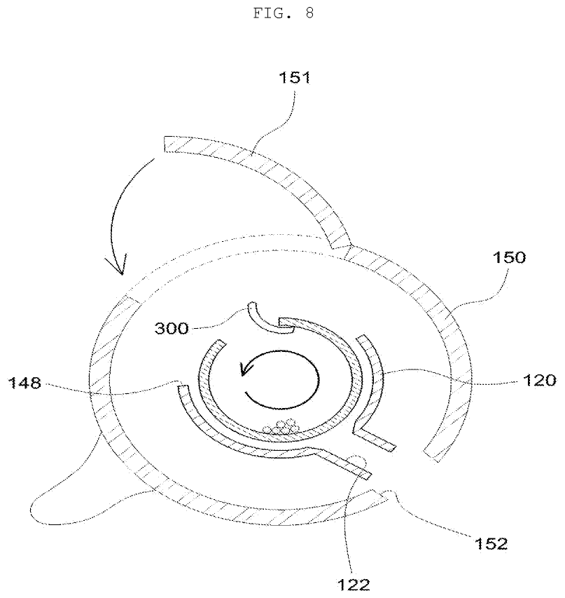

Referring to FIGS. 2 and 8, the position sensing sensor 170 may determine a rotational position of the object box 140.

The control means 160 may rotate the object box 140 to control an object in the object box 140 to be discharged through the object box hole 148 and the discharge hole 122.

Then, the control means 160 may control the object box 140 to return to the specific position and stop. For example, the specific position may be an original position, but the specific position is not limited thereto and may be freely set by a user. Here, the specific position may be obtained based on information obtained by matching an angle of rotation under control of driving means or based on rotational position information obtained through the position sensing sensor 170.

As described above, by controlling the object box 140 to return to its original position, not only consistency of the object box rotation may be precisely controlled, but also the object box hole 148 may be directed downward, thereby preventing the object from being inadvertently discharged through the discharge hole 122.

A discharge detection sensor 195 may sense whether the object has been discharged through the discharge hole 122 and may be disposed near the discharge hole 122. When the object is not discharged based on a signal received from the discharge detection sensor 195, the control means 160 may rotate the object box 140 once more to control the object in the object box 140 to be discharged through the discharge hole 122 to the outside.

Thus, it may be sensed whether the object has been discharged, thereby preventing a case where the object is not discharged.

Referring to FIGS. 2 and 8, the housing 150 may be positioned opposite to the object box hole 148 and may be disposed adjacent to the object box 140 inserted into the object box hole 148, and may include a cover 151 used to insert or withdraw the object box 140.

The control means 160 may rotate the object box 140 to control an object in the object box 140 to be discharged through the object box hole 148 and the discharge hole 121.

Next, the control means 160 may stop the object box 140 such that the object box hole 148 is positioned in a direction (“a specific position”) in which the cover 151 exists, using the rotational position information obtained through the position sensing sensor 170. The specific position may be set in various ways.

As described above, by controlling the object box 140 such that the object box hole 148 is positioned in the direction in which the cover 151 exists, when a user opens the cover 151 and inserts the object, not only the object box hole 148 may be directed toward the cover 151, thereby easily inserting the object, but also the object box 140 may be directed downward, thereby preventing the object from being inadvertently discharged through the discharge hole 121.

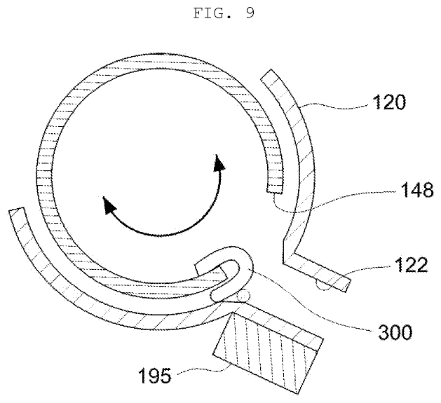

FIG. 9 is a diagram for explaining a method of controlling an object to be discharged by shaking an object box when the object box approaches a discharge hole.

Referring to FIGS. 3 and 9, the control means 160 may rotate the object box 140 by a predetermined time and control an object of the object box 140 to be easily discharged to the outside through the discharge hole 122 by repeatedly shaking the object box 140 a predetermined number of times or a set rotation angle.

For another example, the control means 160 may determine whether the object box hole 148 enters a predetermined distance from the discharge hole 122 by using rotational position information obtained through the position sensing sensor 170. For example, the control means 160 may determine whether the object box hole 148 enters within 1 cm from the discharge hole 122.

When it is determined that the object box hole 148 has entered the predetermined distance from the discharge hole 122, the control means 160 may control an object of the object box 140 to be easily discharged to the outside through the discharge hole 122 by repeatedly shaking the object box 140 a predetermined number of times or a set rotation angle.

The embodiments described above may be configured by selectively combining all or some of the embodiment such that various modifications may be made.

It should also be noted that the embodiments are for the purpose of illustration and not for the purpose of limitation. In addition, it will be understood by those of ordinary skill in the art that various embodiments are possible within the scope of the technical idea of the present invention.

1. A training robot using movable smart home monitoring robot, the training robot comprising:
an object box including an elastic member;
first driving means configured to rotate the object box;
a base disposed spaced from the object box and including a discharge hole connected to an external space;
a position detection sensor configured to determine a rotational position of the object box; and
control means configured to control the first driving means such that when the object box rotates by the first driving means, the elastic member is in contact with another member and bends to generate an elastic force, when the object box rotates to a vicinity of the discharge hole, an object stored in the object box is discharged, the bent elastic member is unbent to a space of the discharge hole to release the elastic force, and the discharged object is pushed into the discharge hole
wherein the control means is configured to rotate the object box to control the object in the object box to be discharged through the discharge hole connected to an outside and then the object box returns to a specific position and stops using rotational position information detected through the position detection sensor.

2. The training robot of claim 1, wherein the control means is configured to control the first driving means such that when the object box rotates by the first driving means, the elastic member is in contact with an inner surface of the base and bends to generate the elastic force.

3. The training robot of claim 1, wherein the base further includes a protrusion disposed on an inner side thereof,
wherein the control means is configured to control the first driving means such that when the object box rotates by the first driving means, the elastic member is in contact with the protrusion and bends to generate an elastic force, when the object box rotates to the vicinity of the discharge hole, the object stored in the object box is discharged, the object box continuously rotates, the elastic member bent by the protrusion is not in contact with the protrusion to release the elastic force, and the discharged object is pushed into the discharge hole.

4. The training robot of claim 1, wherein the object box includes:
a first box including a first half-hole formed at an end and configured to insert or discharge the object; and
a second box including a second half-hole formed at an end of a part opposite to the first hole and configured to insert or discharge the object, and
wherein the first hole and the second hole are combined with each other when the first box and the second box are combined with each other to form a completed object box hole.

5. The training robot of claim 1,
wherein the elastic member includes:
a first member having an elastic force and exposed to an outside through an object box hole; and
a second member coupled to an end of the first member in a vertical direction, and
wherein the object box further includes a fixing member capable of detachably attaching the second member coupled to the first member on an inner surface thereof.

6. The training robot of claim 5, wherein a magnitude of an elastic force that the first member has varies according to a length of the first member exposed to an outside through the object box hole.

7. The training robot of claim 1, wherein the control means is configured to rotate the object box to control the object in the object box to be discharged through the discharge hole connected to an outside and then control the object box to return to a specific position and stops.

8. The training robot of claim 7,
wherein the object box further includes an object box hole, and
wherein the control means is configured to control the object box hole of the object box to return to a specific position and stop by using the rotational position information detected through the sensor.

9. The training robot of claim 1, wherein the control means is configured to control the object in the object box to be easily discharged to the outside through the discharge hole by shaking the object box by a predetermined number of times after rotating the object box by a predetermined angle.

10. The training robot of claim 1, further comprising a position detection sensor capable of detecting a rotational position of the object box,
wherein the object box further includes an object box hole, and
wherein the control means is configured to control the object in the object box to be easily discharged to the outside through the discharge hole by shaking the object box by a predetermined number of times when the object box hole enters a set distance away from the discharge hole using rotational position information detected through the sensor.

11. The training robot of claim 5, further comprising a discharge detection sensor configured to detect whether the object is discharged through the discharge hole or the object box hole,
wherein the control means is configured to control the object box to rotate once more such that the object in the object box is discharged to the outside through the discharge hole when the object is not discharged based on a signal received from the discharge detection sensor.

12. The training robot of claim 1, further comprising:
moving means; and
second driving means disposed between the moving means and the base and connected to the moving means,
wherein the control means is configured to control the second driving means to drive the moving means and move the training robot.
